(19) United States
(12) Patent Application Publication
(10) Pub. No.: US 2019/0024705 A1
(43) Pub. Date: Jan. 24, 2019

(54) COMPOSITE BLOCK BEARING AND METHOD FOR MANUFACTURE

(71) Applicant: Fenner U.S., Inc., Manheim, PA (US)

(72) Inventor: Grant Q. Moyer, Wilmington, NC (US)

(21) Appl. No.: 15/653,088

(22) Filed: Jul. 18, 2017

(51) Int. Cl. F16C 17/02; F16C 33/04; F16C 43/02

(52) U.S. Cl. CPC F16C 17/02; F16C 43/02; F16C 33/04

(57) ABSTRACT

A bearing assembly and method for making a bearing assembly are provided. The bearing assembly includes a rotary bearing, a bearing sleeve and a housing for positioning and retaining the bearing and the sleeve. The bearing includes a convexly curved exterior surface and the bearing sleeve includes a concavely curved interior surface that cooperates with the convexly curve bearing surface. The method includes the step of forming a bearing sleeve so that it has a concavely curved interior surface and the step of molding a housing around the bearing sleeve. The step of molding comprises using a composite material that comprises a non-metal matrix material and reinforcing fibers. The method also includes the step of inserting the bearing into the bearing sleeve after the step of molding so that a convexly shaped curve of the bearing mates with the concave curve of the bearing sleeve.

### FIELD OF THE INVENTION

The present invention relates to a block bearing assembly and a method for manufacturing the assembly. The device provides a bearing support for supporting a rotatable element, such as a rotatable shaft. In particular, the assembly is a composite assembly including elements formed of molded materials and elements formed from metal.

### BACKGROUND OF THE INVENTION

The use of a block bearing for rotationally supporting a shaft is known in the art. Typically, such assemblies incorporate a cast iron or other metallic housing, which increases the weight and cost of such assemblies. Accordingly, there is a need for a block bearing assembly incorporating a non-metal housing that is easily fabricated and able to withstand the stresses imposed on a block bearing assembly.

### SUMMARY OF THE INVENTION

In accordance with the present invention, a bearing assembly for supporting a rotatable shaft is provided. The bearing assembly includes a rotary bearing rotatable about an axis of rotation. The outer surface of the bearing comprises a convexly curved surface. The bearing assembly also includes a bearing sleeve formed of a first material and circumscribing the rotary bearing. The bearing sleeve comprises an exterior surface and an interior surface. The interior surface comprises a concavely curved surface configured to cooperate with the convexly curved surface of the rotary bearing to facilitate relative pivoting motion of the rotary bearing relative to the bearing sleeve about an axis transverse the axis of rotation of the rotary bearing. The bearing assembly also includes a housing formed of a second material. The housing is formed of a second material that is non-metallic and is different from the first material. The housing includes an opening configured to receive the bearing sleeve and the rotary bearing. The housing also includes a first retainer configured to restrain the bearing sleeve against displacement relative to the housing. For instance, the first retainer may be an annular wall formed within the housing.

According to another aspect, the present invention also provides a method for forming a bearing assembly that includes a rotatable bearing that has an external surface forming a convex curve. The rotatable bearing has an internal surface configured to receive a rotatable shaft and the method includes the step of forming a bearing sleeve. The bearing sleeve is formed so that it has an interior surface forming a concave curve. The method also includes the step of molding a housing around the bearing sleeve. The step of molding comprises using a composite material that comprises a non-metal matrix material and a reinforcing material. For instance, the reinforcing material may be reinforcing fibers. The method also includes the step of inserting the bearing into the bearing sleeve so that the convexly shaped curve of the bearing mates with the concave curve of the bearing sleeve. The step of inserting the bearing may occur prior to the step of molding.

### BRIEF DESCRIPTION OF THE DRAWINGS

The foregoing summary, as well as the following detailed description of the preferred embodiments of the present invention, will be better understood when read in conjunction with the appended drawings, in which:

FIG. 1 is a front elevational view of a pillow block assembly.

FIG. 2 is a plan view of the pillow block assembly illustrated in FIG. 1.

FIG. 3 is a sectional view of the pillow block assembly illustrated in FIG. 1, taken along line 3-3.

FIG. 4 is a sectional view of the pillow block assembly illustrated in FIG. 1, taken along line 4-4.

FIG. 5 is an enlarged sectional view of a portion of the pillow block assembly of FIG. 4 designated 5.

FIG. 6 is a sectional of a housing of the pillow block assembly illustrated in FIG. 3.

FIG. 7 is a front elevational view of a bearing of the pillow block assembly illustrated in FIG. 1.

FIG. 8 is a sectional view of the bearing illustrated in FIG. 7, taken along the line 8-8.

FIG. 9 is a side elevational view of the bearing illustrated in FIG. 7.

FIG. 10 is a front elevational view of a bearing sleeve of the pillow block assembly illustrated in FIG. 1.

FIG. 11 is a sectional view of the bearing liner illustrated in FIG. 10, taken along the line 11-11.

FIG. 12 is a rearward elevational view of the bearing liner illustrated in FIG. 10.

FIG. 13 is a perspective view of the bearing liner illustrated in FIG. 10.

FIG. 14 is an enlarged side view of the bearing illustrated in FIG. 7 partially inserted into the bearing liner illustrated in FIG. 10.

### DETAILED DESCRIPTION OF THE PREFERRED EMBODIMENTS

Referring to the figures in general and to FIGS. 1-3 specifically, a pillow block assembly is designated generally 10. The pillow block assembly 10 includes a housing 10 that houses a bearing 50, which is surrounded by a bearing sleeve 70. The pillow block assembly 10 is configured to mount the bearing assembly 50 to support a rotatable shaft 5.

The housing 20 for the pillow block assembly 10 may be formed of any of a variety of materials. Frequently, the housing is formed from a metal, such as cast iron. However, in the present instance, the housing 20 may be formed of a non-metal material. For instance, the housing may be formed from a polymeric or a composite material. Exemplary composite materials include materials that have a polymeric matrix material with a reinforcement element, such as glass fibers, glass balls or other reinforcing material. For example, the composite material may be nylon, such as nylon 6/6, reinforced with glass fibers, such as 33% glass fill. It should be understood that these examples do not limit the variety of materials that can be used to form the housing.

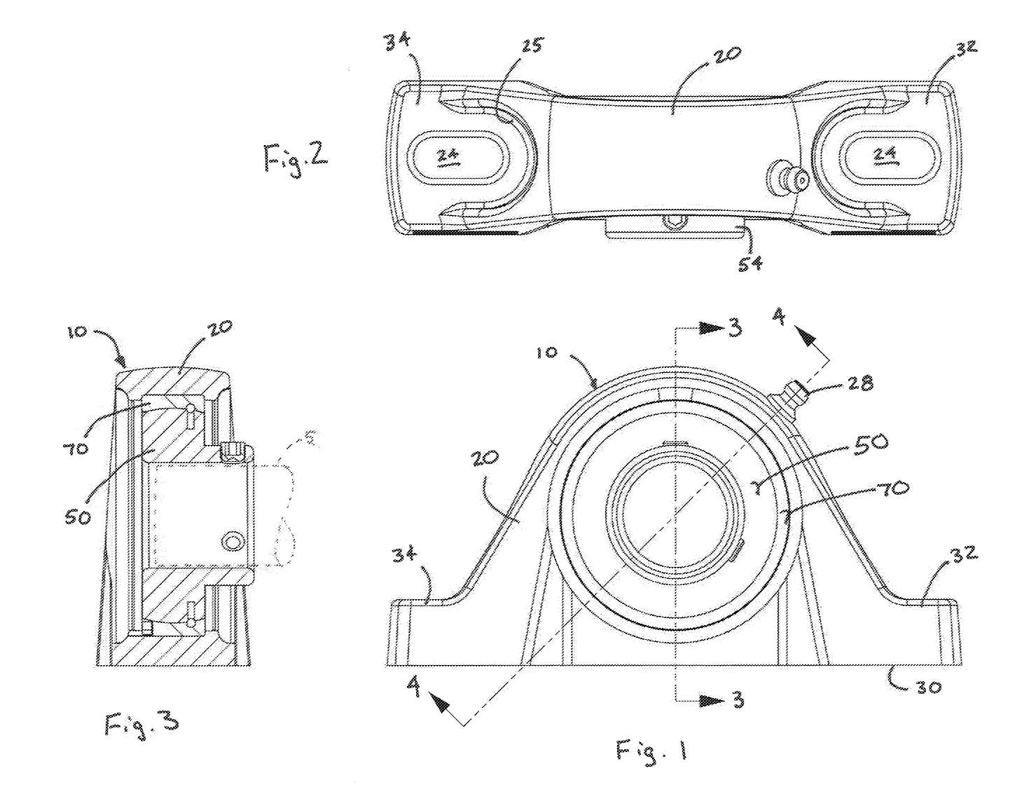

Referring to FIGS. 1-6, the housing 20 comprises a cavity 22 for receiving the bearing 50 and the bearing sleeve 70. The housing may have any of a variety of shapes depending upon the application for the device 10. In the present instance, the housing 20 has a semi-ovate body with a flat base 30 forming a generally planar surface. The base 30 provides a mounting surface (i.e. a surface that will abut the surface onto which the housing will be mounted). A forward portion of the base 30 projects forwardly forming a forward mounting pad 32. A rearward portion of the base projects rearwardly forming a rearward mounting pad 34. Mounting holes 24 extend through the forward and rearward mounting pads 32, 34. The mounting holes 24 are configured to receive a connector, such as a bolt, for connecting the device 10 to a machine or other surface. Additionally, the mounting holes may be elongated to allow adjustment of the housing relative to the connector. As shown in FIG. 2, the housing may be recessed 25 adjacent the mounting pads 32, 34 to provide clearance for inserting connectors into the mounting holes 24.

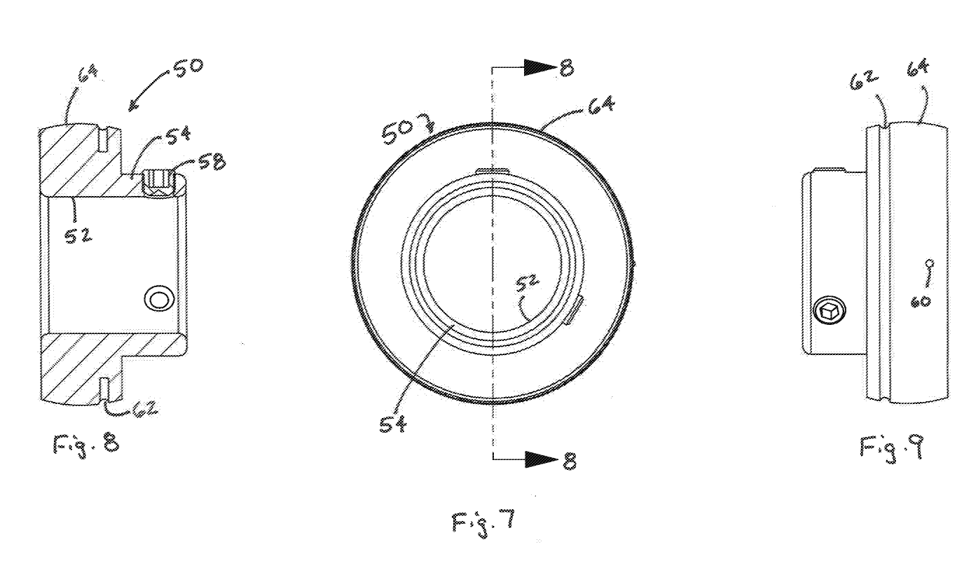

Referring now to FIG. 6, the details of the recess 22 in the housing will be described in greater detail. The recess 22 is configured to receive the bearing 50 and the bearing sleeve 70 as discussed further below. The cavity 22 in the housing includes a through bore that extends through the thickness of the housing. Although a through bore is illustrated, a stopped bore can be used. The housing is formed to provide one or more retaining elements to retain the bearing 50 and the bearing sleeve 70 in the housing. For instance, in the present instance, the housing may include an annular groove 38 sized to receive the bearing sleeve 70. A first annular flange or lip 42 may extend around the interior bore of the cavity 22 adjacent a forward edge of the groove 38 to provide a forward retaining wall. Similarly, a second annular flange or lip 44 may extend around the interior bore adjacent the rearward edge of the groove 38 to provide a rearward retaining wall. In this way, the interior diameter of the groove 38 is greater than the interior diameter of the forward and rearward retaining walls 42, 44. Optionally, the housing may include annular ribs 46, 48 that project radially inwardly from the surface of the retaining walls 42, 44. The annular ribs are narrower than the width of the retaining walls 42, 44 and form snap surfaces for snapping covers over the openings of the cavity 22 to impede the migration of dirt and debris into the housing, thereby limiting the buildup of contaminants on the bearing 50.

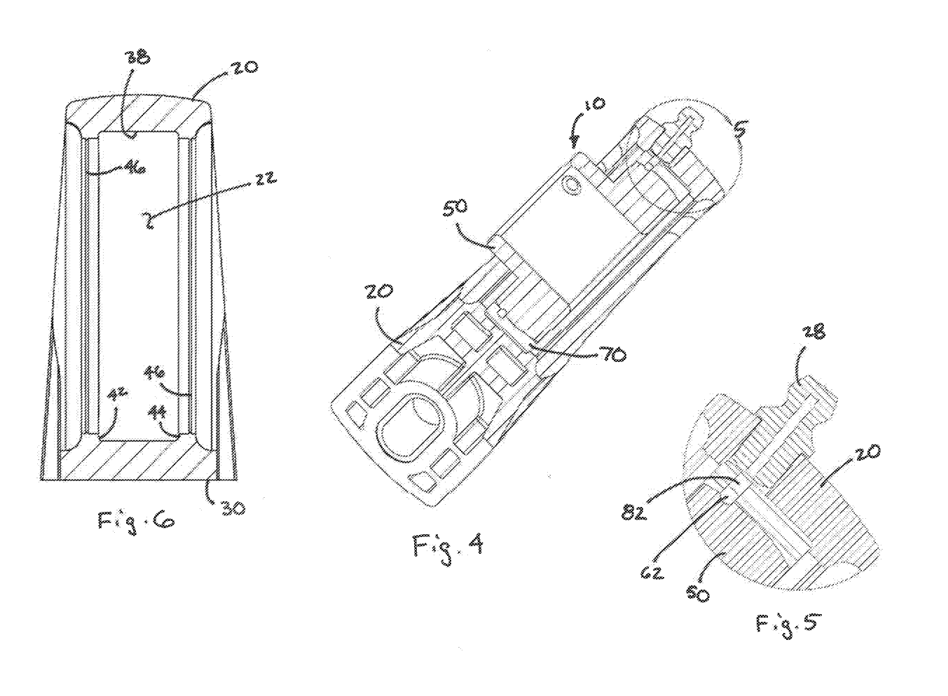

The housing 20 may also include an opening or port that extends from the outer surface of the housing into the interior of the cavity 22 as illustrated in FIGS. 4 and 5. A grease port 28, such as a zerk fitting may be mounted into the access port to facilitate applying lubrication to the bearing as discussed further below.

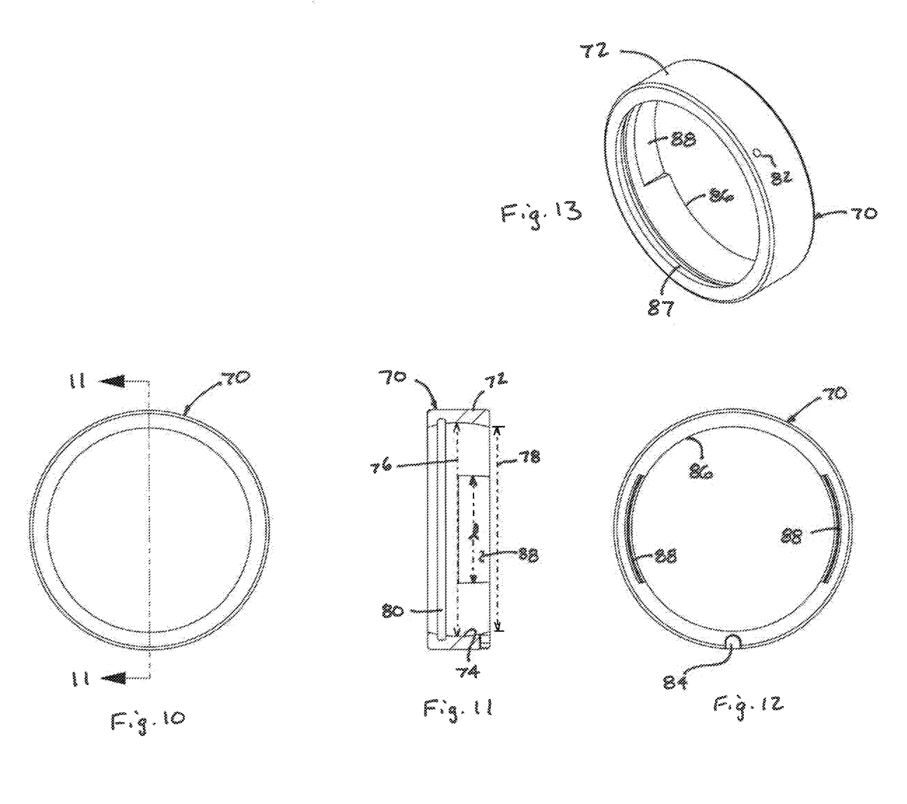

Referring now to FIGS. 7-9, the details of the bearing 50 will be described in greater details. The bearing may be formed of any of a variety of bearing elements, including but not limited to ball bearings, roller bearings, needle bearings and plain bearings. The embodiment illustrated in FIGS. 1-9 incorporates an insert bearing that includes radial bearings. The interior diameter of the bearing forms a cylindrical bore configured to receive the outer diameter of a shaft 5. In the present instance, the interior diameter is formed by an inner race 52 of the bearing. The exterior diameter of the bearing forms a convex surface as shown in FIGS. 8-9. In the present instance, the exterior diameter is formed by the outer race 64 of the bearing. The convex surface is a substantially continuously curved surface from the major diameter of the outer race to the edges of the outer race 64. However, as shown in FIGS. 8 and 9, a circumferential groove 62 may extend around the exterior surface of the outer race to provide a groove for the dispersion of lubrication. As shown in FIG. 8, one or more recesses may extend radially inwardly into the bearing from the circumferential groove 62.

The bearing may be configured to be connected to the shaft 5 in any of a variety of ways. In the present instance, the bearing incorporates a locking mechanism for locking the shaft 5 onto the bearing. In particular, the inner race 52 of the bearing 50 comprises an extended collar or ring that extends axially (i.e. parallel to the axis of rotation) to provide a locking hub or stem 54. As shown in FIGS. 8-9 the locking hub 54 extends outwardly from the edge of the outer race 64. The locking hub 54 may also include a locking element for releasably locking the locking hub to the shaft 5. For instance, the locking hub may include one or more set screws 58.

Referring now to FIGS. 10-13, the details of the bearing sleeve 70 will be described in greater detail. The bearing sleeve 70 is configured to nest within the housing cavity 22 and circumscribe the bearing 50. The sleeve 70 may be formed from any of a variety of materials, including, polymeric, metal or composite materials. In the present instance, the sleeve can be formed from any of a variety of metals, such as sintered iron or machined steel rod. The exterior surface of the outer sleeve is configured to mate with and/or cooperate with the interior surface of the cavity 22 in the housing. For instance, in the embodiment illustrated in FIGS. 10-13, the exterior surface of the bearing sleeve is substantially cylindrical to nest in the annular groove 38 in the housing. However, the exterior surface of the bearing sleeve 70 may have any of a variety of shapes and the cavity 22 may be formed to cooperate with and/or mate with such shapes.

The bearing sleeve 70 has a diameter and a width; and the diameter is larger than the width of the sleeve. Further still, the sleeve diameter may be substantially larger than the width of the sleeve. For example, the sleeve diameter may be at least 50% greater than the width of the sleeve. Further, the sleeve diameter may be at least 100% greater than the width of the sleeve. In some applications the sleeve may be more than 300% greater than the width of the sleeve. In this way, the sleeve diameter may be 50% to 300% greater than the width of the sleeve. For example, in an exemplary embodiment, the sleeve may be approximately 2.3 inches (approx. 58 mm) in diameter and approximately ⅝ inches (approx. 15 mm) wide.

The interior surface of the bearing sleeve 70 may be configured in any of a variety of shapes. For example, the interior surface of the sleeve 70 may be substantially cylindrical. In the embodiment illustrated in FIGS. 10-13, the inner surface 74 of the bearing sleeve 70 is concave. In this way, the interior surface 74 cooperates with and/or mates with the exterior surface of the outer race 64 of the bearing 50. Specifically, the interior surface 74 of the bearing sleeve forms a substantially continuously curving concave surface. The apex of the convex curve is intermediate the two edges. In this way, the interior diameter of the sleeve 70 has a major diameter 76 intermediate the sides of the sleeve. In the embodiment illustrated in FIG. 11, the major diameter 76 is positioned at the midpoint between the edges of the sleeve so that the convex surface is substantially mirrored about the midpoint of the sleeve. The sleeve also comprises a minor diameter 78 adjacent one or both of the edges of the sleeve. In the embodiment shown in FIG. 11, since the concave curve is substantially constant about the midpoint of the sleeve, the inner diameter at each edge of the sleeve is substantially the same and forms the minor diameter 78 of the sleeve. Accordingly, the inner diameter of the sleeve adjacent the edges is less than the inner diameter of the sleeve at a midpoint of the sleeve, thereby forming a reduced diameter lip at one or both of the open ends of the sleeve. In FIG. 13 a lip at the first end of the sleeve is designated 86 and a lip at the opposite end of the sleeve is designated 87.

As noted above, the curvature of the concave interior surface 74 may be a continuously curved surface. The curvature may be configured so that the diameter of curvature of the concave surface is at least 50% of the exterior diameter of the sleeve. Additionally, the diameter of curvature of the concave surface may be less than approximately 95% of the exterior diameter of the sleeve. In some applications, the diameter of curvature may be approximately 90% of the exterior diameter of the sleeve and in some applications, the diameter of curvature may be approximately 80% of the exterior diameter of the sleeve. Similarly, the curvature of the concave curve may be configured so that the difference between the major internal diameter and the minor internal diameter of the sleeve adjacent the edges is less than half the wall thickness of the sleeve 70 (where the wall thickness is the difference between the major diameter and the external diameter of the sleeve). Similarly, the curvature of the concave curve may be configured so that the difference between the major internal diameter and the minor internal diameter is more than 10% of the wall thickness of the sleeve. Additionally, the curvature of the concave curve may be configured so that the difference between the major internal diameter and the minor internal diameter is more than 20% of the wall thickness of the sleeve.

Referring against to FIG. 11, the bearing sleeve 70 may also include an annular groove 80 formed in the interior surface 74. Additionally, the sleeve 70 may include a fluid passage or port 82 through the thickness of the sleeve, intersecting the groove 80. The groove 80 and the port 82 form a fluid path for lubrication to lubricate the bearing 50.

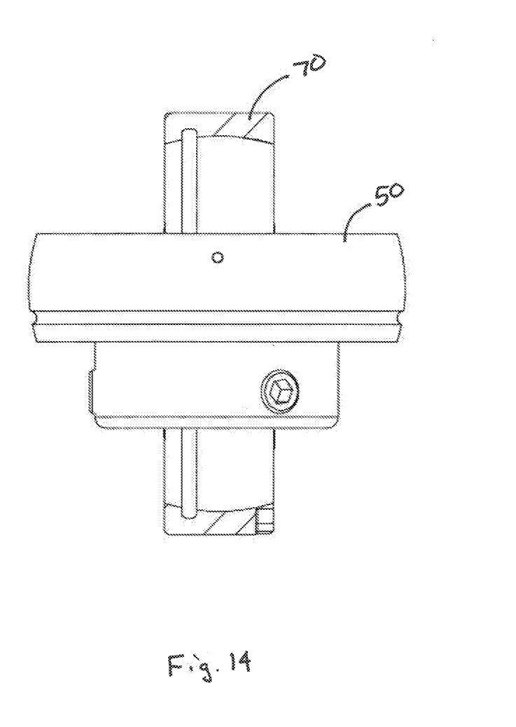

Referring to FIG. 11-13, the bearing sleeve 70 may also include one or more recesses or pockets 88 that extend through the lip 86 at the edge of the sleeve. As discussed further below, the recesses 88 provide clearance through the lip 86 for inserting the bearing 50 into the sleeve 70. In the embodiment illustrated in FIGS. 11-13, the bearing sleeve includes a pair of recesses 88 spaced equidistantly around the circumference of the sleeve so that the recesses oppose one another as shown in FIG. 12. The recesses 88 have a width that extends from the edge of the sleeve to a point at or adjacent the major diameter 76 of the sleeve. The length of each recess 88 (designated “e” in FIG. 12) extends a length at least as great as the width of the outer race 64 of the bearing. The depth of the recess tapers from generally flush with the midpoint of the sleeve (i.e. essentially zero depth) to a maximum depth at the edge of the sleeve. The maximum depth is approximately equal to or greater than the difference between the major diameter 76 and the minor diameter 78. In this way, the recesses 88 extend through the lip 86 of the sleeve.

Referring to FIGS. 11 and 12, the bearing sleeve 70 may also include an optional recess 84 formed at one of the edges of the bearing sleeve. The recess 84 may be used as an alignment element to align the bearing sleeve in a mold as discussed further below.

When configured as discussed above, the device 10 provides a bearing assembly for providing rotational support for a shaft 5. The bearing assembly 10 includes a housing 20 having mounting elements for attaching the bearing assembly to another element, such as a machine. The housing 20 is formed of a first material and the bearing 50 is mounted in a sleeve 70 formed of a second material that is different from the first material. In the present instance, preferably the first material is a non-metallic material and preferably the second material is a metallic material.

The bearing 50 is mounted within the sleeve 70 so that annular groove 80 in the sleeve aligns with and/or overlies the circumferential groove 62 of the bearing 50. Additionally, the grease port 82 in the bearing sleeve 70 aligns with the zerk fitting 28 in the housing so that grease can injected into the bearing through the zerk fitting, which then flows through the lubrication groove 80 in the sleeve and the lubrication groove 62 in the bearing.

The bearing 50 is mounted within the bearing sleeve 70 so that the exterior surface of the bearing is moveable relative to the interior surface of the sleeve 70. In particular, preferably the bearing 50 is pivotable relative to the sleeve 70 about an axis that is transverse the axis of rotation of the shaft 5 and the bearing. More specifically, as illustrated in FIG. 3 the shaft 5 is supported by the bearing such that the axis of rotation of the shaft and the axis of rotation of the bearing are parallel to the planar base 30. However due to alignment issues, the shaft may be disposed at an angle relative to the planar base 30. With the shaft skewed relative to the planar base, the axis of rotation of the bearing may be skewed relative to the shaft. Accordingly, the bearing 50 may pivot relative to the sleeve 70 to align the shaft axis with the axis of rotation of the bearing. For instance, the bearing 50 may pivot clockwise or counter-clockwise relative to FIG. 3 (about an axis normal to the plane of FIG. 3).

In the foregoing discussion, the bearing assembly 10 is described as being connected to and rotationally supporting a first end of a shaft 5. It should be understood that a second bearing assembly 10 may be provided at the second end of the shaft to rotationally support the second end of the shaft so that the shaft is supported between opposing bearing assemblies 10. Alternatively, one end of the shaft 5 may be supported by the bearing assembly 10 and the second end of the shaft may be support by a different assembly. For instance, the second end of the shaft may be driven by a drive element.

### Method of Manufacture

As noted above, the bearing assembly 10 may comprise a housing formed of a non-metal material. Accordingly, the following method describes a method for producing the bearing assembly 10 with a non-metal housing. It should be understood that the bearing assembly may be formed in a variety of processes and is not limited to fabrication according to the following methodology.

A method for producing the bearing assembly 10 includes the step of forming the housing 20 by molding the housing 20. For instance, the housing may be formed by molding, such as injection molding. Prior to molding the housing, the bearing sleeve 70 is inserted into the mold so that the housing is molded around the bearing sleeve. In this way, the housing is formed so that the bearing sleeve is substantially fixedly connected with the housing. In particular, the housing is insert molded so that the bearing sleeve is captured in the annular groove 38 in the cavity 22 between the forward and rearward retaining flanges 42, 44. Accordingly, the retaining flanges 42, 44 act as stops to prevent axial displacement of the bearing sleeve relative to the housing.

Additionally, as noted previously, the housing 20 may include a grease nipple, such as a zerk fitting 28. The zerk fitting 28 may also be inserted into the mold prior to forming the housing. Additionally, the bearing sleeve may include an alignment element to properly orient the bearing sleeve relative to the housing. Specifically, the alignment recess 84 may be aligned with an alignment tab in the mold so that the grease port 82 in the sleeve is aligned with the zerk fitting 28. In this way, the housing is formed around the zerk fitting and the bearing sleeve to provide a continuous fluid path from the fitting into the interior of the bearing sleeve. Alternatively, the mold may be formed so that an access port is provided through the housing and the zerk fitting may be connected to the housing after the step of molding the housing. Further still, the access port may be machined into the housing after the housing is molded.

Referring to FIGS. 12 and 14, before the housing 20 is formed around the bearing sleeve 70, the bearing 50 is mounted into the bearing sleeve. The minor diameter 78 of the bearing sleeve is smaller than the exterior diameter of the bearing 50 at the apex of the convex outer surface of the outer race 64. Accordingly, the bearing 50 is not pressed directly into the sleeve (i.e. such that the axis of rotation of the bearing is aligned with the central axis of the sleeve). Instead, the edge of the bearing is aligned with the recesses 88 in the side of the bearing sleeve 70. Specifically, the bearing 50 is oriented so that the diameter of the bearing is parallel with or aligned with the opening that extends from the first recess 88 to the opposing recess. In this orientation, the bearing 50 is disposed so that the axis of rotation of the bearing is transverse the central axis of the sleeve (which is parallel to the axis of the shaft 5 shown in FIG. 3). In this orientation, the bearing 50 is inserted into the sleeve 70 until the major exterior diameter of the bearing is at or adjacent the major interior diameter 76 in the sleeve. In the present instance, the major diameter of the bearing 50 is at the midpoint of the exterior surface of the bearing, so that the bearing is inserted into the sleeve until half of the bearing is in the sleeve as shown in FIG. 14. The bearing is then rotated clockwise from the perspective of FIG. 14 to mount the bearing into the sleeve.

It will be recognized by those skilled in the art that changes or modifications can be made to the above-described embodiments without departing from the broad inventive concept of the invention. For instance, in the foregoing description the assembly is illustrated and described as a pillow block bearing. In a pillow block bearing the axis of rotation of the bearing (i.e. the axis of rotation of the shaft mounted in the bearing) is in a plane parallel to the plane of the mounting surface for the housing of the pillow block bearing. In contrast, a flange assembly, a bearing block assembly and a take up block assembly each incorporates a housing with a bearing mounted within the housing configured to be mounted in a plane that may not be parallel to the axis of rotation of the bearing. Accordingly, the invention is not limited to pillow block bearings and instead includes various bearing assemblies regardless of the angle of the mounting plane of the housing relative to the axis of rotation of the shaft. Additionally, in the foregoing description the bearing is described as being assembled into the bearing sleeve prior to forming the housing. However, it should be understood that the bearing sleeve may be insert molded into the housing and then the bearing may be assembled into the sleeve after the housing is formed around the sleeve. It should therefore be understood that this invention is not limited to the particular embodiments described herein but is intended to include all changes and modifications that are within the scope and spirit of the invention as set forth in the following claims.

1. A bearing assembly for supporting a rotatable shaft, comprising:
a rotary bearing rotatable about an axis of rotation and having an inner race and an outer race, wherein the outer race comprises a convexly curved surface;
a bearing sleeve formed of a first material and circumscribing the rotary bearing, wherein the bearing sleeve comprises an exterior surface and an interior surface, wherein the interior surface comprises a concavely curved surface configured to cooperate with the convexly curved surface of the rotary bearing to facilitate relative pivoting motion of the rotary bearing relative to the bearing sleeve about an axis transverse the axis of rotation of the rotary bearing;
a housing formed of a second material and having an opening configured to receive the bearing sleeve and the rotary bearing, wherein the housing comprises a first retainer configured to restrain the bearing sleeve against displacement relative to the housing; wherein the second material is non-metallic and is different than the first material.

2. The bearing assembly of claim 1 wherein the first material comprises metal.

3. The bearing assembly of claim 1 or two wherein the second material is a composite material.

4. The bearing assembly of any of claims 14 wherein the second material comprises a polymer matrix material and reinforcing fibers.

5. The bearing assembly of any of claims 14 wherein the housing comprises one or more mounting elements configured to mount the housing on a machine.

6. (canceled)

7. The bearing assembly of claim 1 wherein the housing comprises a second retainer configured to restrain the bearing sleeve against displacement relative to the housing.

8. The bearing assembly of claim 1 wherein the first retainer comprises a first annular wall formed within the opening of the housing projecting radially inwardly toward the axis of rotation of the bearing.

9. (canceled)

10. The bearing assembly of claim 1 wherein the second retainer comprises a second annular wall formed within the opening of the housing projecting radially inwardly toward the axis of rotation of the bearing.

11. (canceled)

12. The bearing assembly of claim 1 wherein the bearing sleeve comprises a major interior diameter between a first edge and a second edge of the bearing sleeve and a minor diameter spaced apart from the major diameter.

13. (canceled)

14. (canceled)

15. The bearing assembly of claim 12 wherein the concave surface of the bearing sleeve has a diameter of curvature that is at least 50% of the exterior diameter of the bearing sleeve.

16. The bearing assembly of claim 12 wherein the concave surface of the bearing sleeve has a diameter of curvature that is less than 95% of the exterior diameter of the bearing sleeve.

17. (canceled)

18. (canceled)

19. The bearing assembly of claim 12 wherein the bearing sleeve comprises a wall thickness between the exterior diameter and the major interior diameter, wherein the concave surface of the bearing sleeve is configured so that the difference between the major internal diameter and the minor internal diameter of the sleeve adjacent the edges is less than half the wall thickness of the bearing sleeve.

20. (canceled)

21. (canceled)

22. The bearing assembly of claim 12 wherein the bearing sleeve comprises a lip formed adjacent the minor diameter and at least one recess formed in the lip to facilitate insertion of the bearing into the bearing sleeve.

23. The bearing assembly of claim 22 wherein the bearing sleeve comprises a second recess formed in the lip wherein the two recesses oppose one another forming a slot to facilitate insertion of the bearing into the bearing sleeve.

24. The bearing assembly of claim 23 wherein the outer race of the bearing has a width and the two recesses each has a length that is greater than the width of the outer race of the bearing.

25. The bearing assembly of claim 22 wherein the at least one recess has a width that extends from the edge of the bearing sleeve to the point of the major internal diameter.

26. The bearing assembly of claim 1 wherein the convex curve substantially continuously curves across the width of the outer race of the bearing.

27. The bearing assembly of claim 1 wherein the concave curve of the bearing sleeve substantially continuously curves across the width of the bearing sleeve.

28. A method for forming a bearing assembly having a rotatable bearing having an external surface forming a convex curve and an internal surface configured to receive a rotatable shaft, comprising the steps of:
forming a bearing sleeve having an interior surface forming a concave curve;
molding a housing around the bearing sleeve, wherein the step of molding comprises molding a composite material comprising a polymer and reinforcing material;
inserting the bearing into the bearing sleeve, wherein the step of inserting so that the convexly shaped curve of the bearing mates with the concave curve of the bearing sleeve.

29. (canceled)

30. The method of claim 28 wherein the step of molding comprises insert molding.

31. The method of claim 28 wherein the step of forming the bearing sleeve comprises the step of forming a plurality of recessing in an edge of the bearing sleeve.

32. The method of claim 31 wherein bearing sleeve comprises a central axis and the bearing comprises an axis of rotation, wherein the step of inserting the bearing comprises the step of orienting the bearing so that the axis of rotation is transverse the central axis and inserting the bearing into the recesses.

33. The method of claim 32 wherein the step of inserting the bearing comprises the step of pivoting the bearing relative to the bearing sleeve after the step of inserting the bearing into the recesses.

34. The method of claim 33 wherein the step of pivoting the bearing comprises pivoting the bearing about an axis transverse the central axis.

35. The method of claim 28 wherein the step of forming a bearing sleeve comprises forming the bearing sleeve out of metal.

36. The method of claim 28 wherein the step of inserting the bearing sleeve comprises inserting the bearing into the sleeve so that the convex surface of the bearing cooperates with the concave surface of the bearing sleeve to facilitate pivoting of the bearing relative to the bearing sleeve to facilitate alignment of the bearing axis of rotation with the axis of rotation of the shaft.

37. The method of claim 28 wherein the step of molding comprises molding a composite material comprising a polymer and reinforcing fibers.

38. The method of claim 28 wherein the step of inserting the bearing comprises inserting the bearing before the step of molding the housing around the bearing sleeve.
